(19) United States
(12) Patent Application Publication
(10) Pub. No.: US 2021/0380069 A1
(43) Pub. Date: Dec. 9, 2021

(54) ELECTRONIC CIRCUIT DEVICE FOR CONSTANTLY MONITORING THE CORRECT USE OF A SAFETY BELT IN THE AREA OF A VEHICLE

(71) Applicant: LEX BLOX LLC, Newark, DE (US)

(72) Inventors: Mathias Sielecki, Buenos Aires (AR); Mauricio Dobboletta, Santa Fe (AR)

(73) Assignee: LEX BLOX LLC, Newark, DE (US)

(21) Appl. No.: 16/322,769

(22) PCT Filed: Aug. 1, 2017
(86) PCT No.: PCT/US2017/044875

§ 371 Date: Feb. 1, 2019

(30) Foreign Application Priority Data
Aug. 1, 2016 (AR) P 20160102345

(51) Int. Cl. B60R 22/48; B60R 22/12

(52) U.S. Cl. CPC B60R 22/48; B60R 2022/4866; B60R 2022/485; B60R 22/12

(57) ABSTRACT

Electronic circuit device for constantly monitoring the correct use of the safety belt in the area of a vehicle, comprising: general power supply battery and a ignition key; one or more infrared light emitting diodes located at the upper part facing each of the positions of the driver and/or passenger; one or more pulse generators (G_{E}, . . . , G_{En}) connected to one or more infrared light emitting diodes; one or more infrared light receiving diodes located at each position with a safety belt; one or more infrared light receiving diodes in each of the safety belts located on the diagonal strap thereof; one or more electronic circuits consisting of two Steps 1 and Stage 2 associated in conjunction with each safety belt, Step 1 commanded by the infrared light receiving diode located in the seat of the driver and/or passengers determines the presence or absence of an occupant and Stage 2 commanded by the infrared light receiving diode located in the diagonal strap of the safety belt is enabled according to the status of Step 1, determining the use of the safety belt; and an audible and/or luminous alarm with an associated timer circuit within the area of use of the safety belt integrated for all devices; each set of steps 1 and 2 of the one or more operating circuits working autonomously for each of the safety belts.

### FIELD OF THE INVENTION

The present invention relates to constant monitoring equipment which avoids the disablement and/or violation of the use of the safety belt by means of strategies taken by the driver of a vehicle or persons accompanying the driver.

### BACKGROUND OF THE INVENTION

Brief historical review of the safety belts:

In 1903 Gustav Desire invented the safety belt.

In 1930 safety belts were experienced in aviation.

Preston Tucker in the late 1940s introduced the safety belt as a possible solution to deaths due to road accidents.

In 1956 Ford takes up the idea of Tucker and introduces the two-point safety belt in the front seats as an option of equipment in vehicles. Volvo and Chrysler join this proposal.

In 1959 Volvo introduces the three-point safety belts invented by Nils Bohlin in 1957.

In 1960 Mercedes and Volvo incorporate safety belts in rear seats.

In 1967 Volvo offers three-anchoring point safety belts in rear seats as an option.

In 1984 New York becomes the first place where it is mandatory to wear the safety belt. Mercedes presents the safety belt with pretensioner.

In 1985, the safety belt was declared one of the 8 best inventions of the 20^{th} century.

In 2000 the company B. F. Goodrich presents the Smartbelt or safety belt with airbag.

A further improvement involves safety belts with an explosive charge, which at the time of a strong deceleration, detonate and tighten the safety belt against the seat and its occupant thus preventing the rebound after the crash.

We can say that the safety belt saves thousands of lives around the world, and could prevent many more deaths if used correctly by all drivers and their companions. Experts agree that wearing it dramatically raises the chances of survival of users involved in a car accident.

For example, in France the right front seat or the companion seat is often called the “dead man's seat”, which dramatically shows the consequences of this situation due to the non-use of safety belts.

According to comparative statistics carried out by the National Road Safety Agency (Argentina), results of physical damages related to vehicle accidents with and without the use of the safety belt are provided in the following statistics of 2010:

| Type of injury | Driver | Passenger |
|---|---|---|
| Brain Injuries | 33% | 56% |
| Skull fracture | 18% | 18% |
| Wounds on the face | 45% | 64% |
| Eye Injuries | 38% | 40% |
| Facial Fractures | 6% | 6% |
| Pulmonary Injuries | 33% | 58% |

According to some studies, safety belts reduce the risk of dying in the front seats by 50 percent.

The basic idea of a safety belt is quite simple: it prevents the driver and the eventual passenger/s from flying through the front windscreen or moving inside the vehicle uncontrollably in a frontal or lateral collision, or in a rollover due to the inherent inertia of the movement.

Newton's first law, which stipulates the principle of inertia, tells us that a body at rest or in motion, whether uniform or rectilinear, will remain in a state of rest or will preserve its movement quantitatively, keeping its velocity unchanged (in magnitude and direction), If the forces acting on it from the outside are equal to zero. Inertia is directly proportional to the mass of the body.

If a car goes at 30 kilometers per hour, the principle of inertia states that it must continue advancing at 30 kilometers per hour if there is no outside force to stop it; air resistance and friction with the road are continuously stopping the vehicle but the engine power compensates this loss of energy making it able to maintain that speed.

In these conditions everything that is inside the car, including the driver and passengers, has its own inertia according to the mass of each of them.

If the car crashes against something, it will be obvious that the inertia of the vehicle and the passengers are independent. The crash will stop the car abruptly, and the occupants' bodies will tend to keep moving until they hit against the interior parts of the car or against something that may stop them. The force undergone by a vehicle or a person when it reduces its speed from an “X” value to another “Z” value is directly proportional to the mass due to the deceleration suffered.

A safety belt provides a force equal and opposite to that of the inertia; the bodies of the occupants of the vehicle are also going to bear a strong impact against the belt fabric but the distance traveled by the bodies will be minimal thus preventing them from hitting against interior elements of the car or being thrown out of it.

Different types of safety belts are known for motor vehicles and they all have the same objective which is to save the life of occupants of a vehicle in case of an accident. Best known safety belts are:

The lap belts are simple adjustable straps on the waist to steady the user to his/her seat but without holding the upper body. They were used primarily and even today they can be seen in the rear seats.

The lap and shoulder belts combine the lap belt with a diagonal that gives resistance to the shoulder and upper part of the body of the user preventing him/her from moving while protecting the spinal column during a collision. The diagonal strap is designed to rest on the clavicle and to pass in front of the user's chest. They can be found in the front and rear seats of some vehicles, with both ends attached to the frame and a third point adjusts them.

The three-point belts are similar to the previous ones but are made of a continuous belt that avoids a fixed assembly as it passes through the frame and then through the body in an adjustment system. This allows the collision energy to be distributed between the chest, shoulders and pelvis.

Five-point belts are usually found in racing cars and in child seats, and their design is much more restrictive but more secure. It is essentially two combined shoulder belts, each mounted on a frame and connected to a strap between the legs to complete the five points.

Inertial belts are not considered a safety belt, although they make the belt more comfortable without totally losing its functionality. In a collision they allow the release of as much strap as is necessary but they lock in a point to prevent the release of more strap than necessary and allow fitting the occupant of the seat.

A traditional safety belt is then substantially composed of a resistant strap where both ends are fixed to the vehicle structure, one directly and the other by the strap winding equipment and the inertial system of said equipment. The strap leaves the winding box and passes through a steel ring that is fixed to the side of the vehicle above the seat. In the strap there is a sliding male connector which is held in accessible position by means of a plastic button inserted in the strap as a catch in the lower part thereof.

By taking the belt by said connector and gently pulling the strap unwinds from the box and is directed to a third fastening point constituted of a female connector fastened by means of a piece of strap to the floor of the vehicle.

In this way the three-point belt is configured which is the most widely used, with the part that passes through the steel ring that is fixed on the side of the vehicle above the seat being the one that goes over the seat or the occupant thereof diagonally being unwound from the equipment where the belt is wounded and the inertial system, above the occupant's thorax, and the belt itself extends from the first attachment point and the third point in such a way that when the occupant is taken at the bottom it goes through the pelvis by the lower part of the abdomen horizontally to the seat and another portion of the strap, that starting from the upper part of the seat, descends diagonally on the thorax of the occupant of the seat.

Both portions of the strap are attached to the structure of the vehicle, the lower one is directly attached to the floor thereof as the upper one that makes it through the equipment for winding the strap and the inertial system also fixed to the structure of the vehicle. The lower and diagonal portions of the strap are joined through a locking hook in solid form, this hook being normally a male connector which is threaded through in said strap and which maintains its accessible position by means of a fixed or height adjustable stop. On the other side of the seat there is a female connector fixed to the floor of the vehicle or to the side of the seat by means of a segment of strap which is generally adjustable and wherein the male connector is engaged with the female connector to close the safety belt.

When the belt is properly placed, the stopping force is mostly applied to the torso, but when being extended over a wide part of the body, power is not concentrated on a single area, reducing the damage that the pull could cause to the user.

Some automobile manufacturing sites implement alarm systems that warn the driver that the belt/s is/are unbuckled and must be buckled. However, known alarms can be tampered or manipulated so that the alarm stops ringing in such a way that the driver and passengers may travel unprotected.

It is therefore necessary to have a simple and effective alarm system that effectively and inviolably prevents both the driver of a car and his/her companions from not wearing safety belts, thus avoiding fatal accidents in a friendly and safe manner.

### SUMMARY OF THE INVENTION

It is therefore the object of the present invention, an electronic circuit device for constantly monitoring the correct use of the safety belt in the area of a vehicle, comprising:
a general power supply battery and a ignition key for said battery belonging to the vehicle;
one or more infrared light emitting diodes preferably located facing each or more of the positions of the driver and/or passenger on the roof or in the upholstery of the vehicle roof;
one or more pulse generators (G_{E}, . . . , G_{En}) connected to one or more infrared light emitting diodes;
one or more infrared light emitting diodes located in the seat of the driver and of each passenger and/or at each position where a safety belt is fitted;
one or more infrared light receiving diodes in each of the safety belts corresponding to each seat preferably located in the diagonal strap of the safety belt;
one or more electronic circuits, each consisting of two steps known as Step 1 and Step 2 together associated with each safety belt, wherein Step 1 commanded by the infrared light receiving diode located in the seat of the driver’ and/or passengers determines the presence or absence of an occupant in the seat and Step 2 commanded by the infrared light receiving diode located on the diagonal strap of the safety belt, which is enabled according to the status of Step 1, determines the correct or incorrect use of the safety belt; and
an audible and/or luminous alarm with an associated timing circuit, within the area of use of the safety belt, which is integrated for all devices;

wherein each set of Steps 1 and 2 of the one or more operating circuits work autonomously for each of the safety belts arranged in the vehicle according to the logic of the following Table:

| | Chof | | | | | | | | | | | | Signal |
|---|---|---|---|---|---|---|---|---|---|---|---|---|---|
| Cont | But | Cint | De | D1 | Z1 | Q1 | Re1 | D2 | Z2 | Q2 | Re2 | Da | Alarm |
| Yes | Des | Sin col. | Em Luz | R/Luz | Cond | Corte | Pos1 | Nr/Luz | N/Cond | XX | XX | XX | N/Act |
| Yes | Oc | M/col | Em Luz | Nr/Luz | N/Cond | Sat | Pos 2 | Nr/Luz | N/Cond | Sat | Pos 2 | Cond | Act |
| Yes | Oc | B/col | Em Luz | Nr/Luz | N/Cond | Sat | Pos 2 | R/Luz | Cond | Corte | Pos 1 | N/Cond | N/Act |

wherein,

Cont=Ignition;

Chof But=Driver's seat: Des=unoccupied, Oc=occupied;

Cint=Belt: Sin Col=Not Placed, M/Col=Misplaced, B/Col=Well placed;

Receiving Diodes D1, D2: N/Luz=Not Receiving Light, R/Light=Receiving Light;

Emitting Diode D_{E}: Em Luz=emits light;

Diode Da: Cond=conducting, N/Cond=not conducting;

Zener Diodes Z1, Z2: Gond=conducting, N/Cond=not conducting;

Re=Relay: 1=Position 1; 2=Position 2;

XX=Irrelevant;

Transistors Q1, Q2: Sat=Saturation, Cort=Cut-off; and

Alarm: Act=Activated, N/Act=Not Activated.

Preferably, each circuit associated with one or more safety belts comprises:
one or more infrared light emitting diodes, D_{E}, . . . , D_{En}, corresponding to each pair of Steps 1 and 2;
two or more pairs of diodes sensitive to the infrared light, D1-D2, . . . , Dn-Dn+1, corresponding to each pair of Steps 1 and 2;
two or more integrated circuits which amplify the signal emitted by the two or more pairs of diodes sensitive to the infrared light, IC1-IC2, . . . , ICn-ICn+1, corresponding to each pair of Steps 1 and 2;
two or more Zener diodes, Z1-Z2, . . . , Zn-Zn+1, corresponding to each pair of Steps 1 and 2;
at least two transistors, Q1-Q2, . . . , Qn-Qn+1, Darlington pair type, corresponding to each pair of Steps 1 and 2, being arranged to work at both ends of their curve: cut-off or saturation; and
one or more relays, Re1-Re2, . . . , Rn-Rn+1, corresponding to each pair of Steps 1 and 2.

More preferably, the one or more pulse generators, G_{E}, G_{En}, are activated when the key of the vehicle is in the starting position.

Most preferably, the one or more infrared light emitting diodes D_{E}, . . . , D_{En}, are suitably located in the area of the vehicle to illuminate the one or more seats and the corresponding pectoral strap of the safety belt when it is correctly placed.

Still more preferably, the one or more diodes sensitive to infrared light of Step 1, D1, . . . , D1n, are located in the seat where the driver is located and in the seats of the companions or passengers, and wherein the one or more diodes, D1, . . . , D1n, are illuminated by the one or more infrared light emitting diodes, D_{E}, . . . , D_{En}, while the seats are not occupied by a person.

Still more preferably, the one or more diodes sensitive to infrared light of Step 1, D1, . . . , D1n, are located in the seat where the driver is located and in the seats of the companions, and wherein said one or more diodes sensitive to infrared light, D1, . . . , D1n, are not illuminated by the one or more infrared light emitting diodes, D_{E}, . . . , D_{En}, while the seats are occupied by a person, the one or more integrated circuits, IC1, . . . , IC1n, being associated with said diodes, D1, . . . , D1n

Preferably, the one or more diodes, D2, . . . , D2n, are located in the chest strap of the safety belt of each seat of the vehicle where the driver and the companions are located, wherein said one or more diodes sensitive to infrared light, D2, . . . , D2n, are illuminated by the one or more infrared light emitting diodes, D_{E}, . . . , D_{En}, only when each belt is correctly placed, whereas it will not be illuminated by the one or more infrared light emitting diodes, D_{E}, . . . , D_{En}, when each belt is wound up, placed behind the driver's or passenger's back, placed behind the respective seat, or twisted, so that the one or more receiving diodes, D2, . . . , D2n, rest on the chest of the passenger and are hidden by strap of the belt or by some element that prevents the passage of infrared rays.

More preferably, the one or more pairs of diodes sensitive to infrared light, D1-D2, . . . , Dn-Dn+1, command the one or more pairs of Zener diodes, Z1-Z2, . . . , Z1n-Z2n, which in turn command the cut-off or conduction of pairs of transistors, Q1-Q2, . . . , Qn-Qn+1, corresponding to the Darlington pair type, arranged to work at both ends of their curve: cut-off or saturation.

Still more preferably, the one or more pairs of transistors, Q1-Q2, . . . , Qn-Qn+1, corresponding to the Darlington pair type, command one or more pairs of relays, Re1-Re2, . . . , Re1n-Re2n, wherein the transistor Q1 commands the relay Re1, the transistor Q2 commands the relay Re2, and so on as appropriate.

Incidentally, in the case where the key of the vehicle is in the starting position and the seat is occupied, the transistor Q1 goes to the saturation state and the relay Re1 changes its position by feeding +B to the Q2 of Step 2 of the circuit, where if the diode D2 does not receive light, Z2 does not conduct and the relay Re2 is in position 2, according to Table 1, biasing the diode Db that feeds the alarm, which when this situation lasts, for a time determined by the timer associated with the alarm, with the diode D2 of the safety belt corresponding to Step 2 not receiving the infrared light, as a signal that the belt is not correctly positioned, will trigger the alarm; on the other hand, if the diode D2 receives light, Z2 conducts and the transistor Q2 works in the saturation state, the relay Re2 goes to position 1, where it stops biasing the Db by cutting-off the supply of the alarm and therefore the alarm.

Preferably, the relay Re1, when the driver's seat is occupied, enables Step 2 of the electronic circuit of the driver seat.

More preferably, at the time the driver's seat is occupied, all the circuits corresponding to the passengers or companions are enabled by supplying a voltage +B to the manifold Q1 of Step 1 of the circuit of each passenger.

More preferably, the relay 2, Re2, is in a condition to enable the audible and/or luminous alarm only in the case where the key of the vehicle is in the starting position, the seat is occupied and the diode which is in the safety belt does not receive light from one or more emitting diodes, D_{E}, . . . , D_{En}, for more than 10 to 15 seconds, either because the belt is wound, or placed behind the back or behind the respective seat or with the twisted belt in such a way that the one or more receiving diodes, D2, . . . , D2n, are resting on the passenger's chest and hidden by the strap of the belt to the infrared rays or by some element that prevents the passage of infrared rays.

Even more preferably, the audible and luminous signal of the board of the vehicle is disabled when the key of the vehicle is in the starting position, the driver's seat is occupied and, if and only if, the safety belt is passed in front of the driver's chest without being twisted and the diode sensitive to infrared light D2, . . . , D2n, is illuminated by the infrared light emitting diode D_{E}, . . . , D_{En}.

Incidentally, when the driver is seated, he/she enables the circuits of the passengers' seats and, if and only if one of the passengers is seated, it enables the alarm, in which case, in order to avoid sounding, the safety belt must be fitted such that the diode sensitive to infrared light, D2, . . . , D2n, of the passenger receives the infrared light.

Preferably, in the passenger's position, the relay Re2 is in a condition to enable the audible and luminous alarm of the board of the vehicle only in the event that the key of the vehicle is in the starting position, the driver's seat is occupied, the seat of any passenger is occupied and the diode which is on the safety belt of the driver and/or passenger does not receive light from the emitting diode D_{E}, . . . , D_{En}, for more than 10 to 15 seconds, either because each belt is wound, placed behind the back of the driver or passenger, placed behind the respective seat, or twisted, in such a way that the one or more receiving diodes, D2, . . . , D2n, are resting on the passenger's chest and hidden by the strap of the belt to the infrared rays or by some element that prevents the passage of infrared rays.

Also preferably, when the key of the vehicle is in the starting position, the driver's seat is occupied and the passenger circuits are enabled by the relay Re1 of Step 1 of the driver's seat, the one or more passenger circuits need the same steps to activate or deactivate the alarm, with the proviso that if nobody occupies the one or more of the seats of the passengers the alarm is not enabled.

### BRIEF DESCRIPTION OF FIGURES

FIG. 1 shows a three-point safety belt according to the installed prior art.

FIG. 2 shows the detail of the one or more diodes associated with the belt.

FIG. 3 shows a preferred location of the infrared light emitter.

FIG. 4 shows a preferred electronic connection for several diodes in the belt in order to obtain a positive output signal upon blocking the infrared rays in some of them.

FIG. 5 shows a block diagram of a preferred embodiment of the device with electronic circuit for constantly monitoring the correct use of the safety belt in the area of a vehicle according to the present invention.

FIG. 6 shows the operating electronic circuit of a preferred embodiment of the device with electronic circuit for constantly monitoring the correct use of the safety belt in the area of a vehicle according to the present invention.

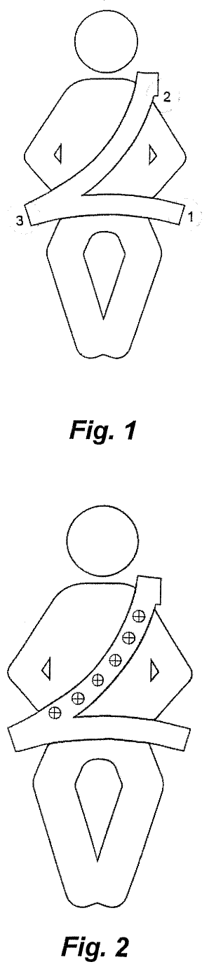

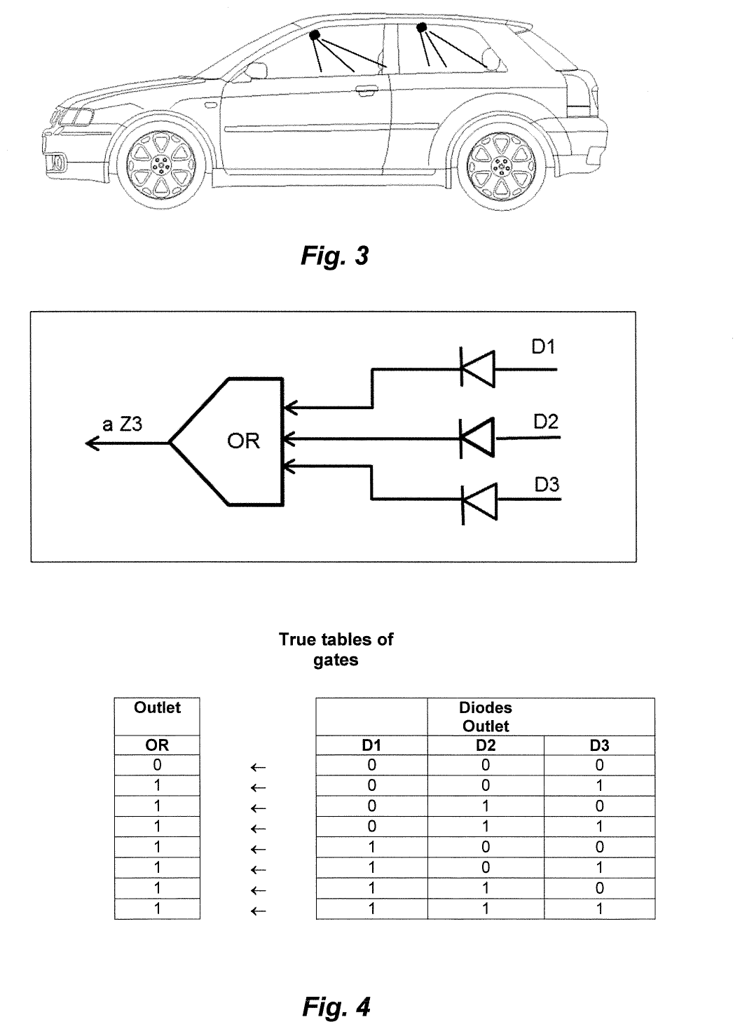

### DETAILED DESCRIPTION OF THE INVENTION

The electronic circuit device for constantly monitoring the correct use of the safety belt in the area of a vehicle according to the present invention consists of one or more diodes working within the infrared spectrum located in each seat of the vehicle. They are distributed as follows:
one or more infrared light emitting diodes located in front of each vehicle seat, preferably facing the driver and/or passenger in the roof or in the upholstery of the vehicle roof;
one or more infrared light emitting diodes located in the seat of the driver and/or passenger in each position where a safety belt is fitted;
one or more infrared light receiving diodes in each of the safety belts corresponding to each seat preferably located in the portion of the diagonal strap of the safety belt.

The aim of this invention is to prevent safety belts from being used incorrectly by evading current safety standards; for example, that the safety belt is fastened behind the passenger's back, that it be placed behind the seat, or that the safety belt is twisted over the driver's or passenger's chest.

Each of the seats, driver and passengers, is assigned the same circuit that consists of two steps in which only the one belonging to the driver has an additional function, which is to connect the circuits of passengers to the general system when the driver sits in his/her seat.

Each of the two steps, which make up each of the circuits of each of the positions of the passengers, interact with each other within each circuit to indicate the correct positioning of the safety belt avoiding possible violations of the safety systems in force.

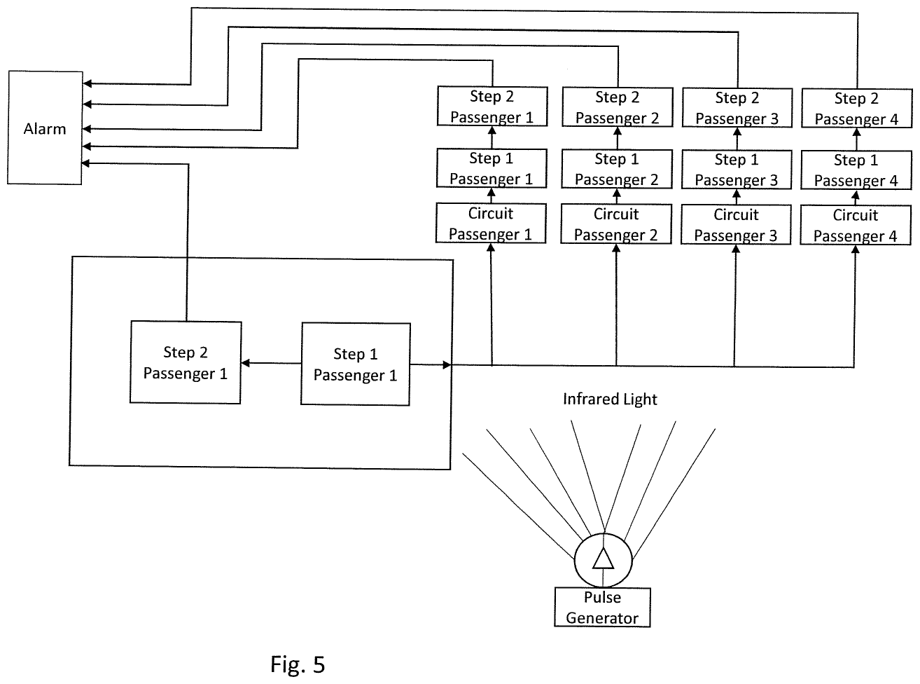

FIG. 5 shows the general block diagram for the entire arrangement wherein the pulse generator feeds a diode emitting an infrared light beam, D_{E}, the diodes receiving that infrared light beam which is in Step 1, D1, and in Step 2, D2, of each of the circuits, are activated from a conduction to non-conduction state upon only receiving the illumination of the infrared light beam emitted by the D_{E} diode when the corresponding circuits are fed by the correct voltage.

The aperture of the angle of the infrared light f the D_{E} diode must be such as to illuminate the seats of the chairs as well as the pectoral or diagonal strap of the safety belt when in place; this position of the D_{E} diode must provide a wide range of illumination, considering people of great physical body or newspapers being read by passengers, and at the same time it must illuminate the whole chair in such a way to include the receiving diodes when the belt is unwound.

In a preferred embodiment of the present invention, only one receiving diode is placed in the strap of the safety belt, this is the way in which the present explanation of the electronic operation will be developed.

In another preferred embodiment, several diodes are placed in the diagonal strap of the safety belt with its individual output connected to an OR gate as attached in FIG. 4 so as to keep the alarm off even if one of them does not receive the beam of light when being obstructed by the movement of the arms, or by a book or journal that is read by the companions.

In another preferred embodiment, there are also included several diodes connected in parallel in which all their outputs behave as a single diode D2 fulfilling the same function as above.

It is important to note that in case of a violation of the system either by passing the belt behind the back of occupants of the seats or by passing it behind the seat, the D2 receiver/s do not take the incidence of infrared light from D_{E} in any possible position, even in case of closing the connection of the safety lock, typical of vehicles at present. It should be mentioned that the present invention adds the operation of the device currently used in vehicles, thus avoiding the possibility that the positioning of the belt, while still meeting the objective of the present invention, does not engage the third fastening point of the belt, therefore the belt could correctly be placed but not buckled.

In addition, it should be noted that this system must be used by all occupants of the vehicle and therefore belts in case there is one or more occupants seated in their seats must be with the belts correctly placed and also engaged to the third point of their seats since the emitting diode D_{E} does not illuminate any receiving diodes D2 when the belt is wound. This situation will give rise to the operation of the alarm that will only occur in the case of passengers if, and only if, the driver's seat is occupied or the diode D1 is not receiving infrared light, since it is the seat of the driver the one that enables the passenger safety system.

When the ignition key is in any position in which the engine of the vehicle is stopped, i.e. the key is not in the ignition position, no circuit is energized. When the key is in the ignition position and the engine is running or not, only the driver circuit is energized but the alarm is not activated. Instead, if the driver occupies his/her place, or for any reason there is a paper on the seat, interrupting the light beam to the diode D1 of Step 1, two instances occur:

i) Diodes D2 of Step 1 of each of the circuits of the passengers are activated, when receiving the supply voltage, but as they are not occupying their place, i.e. the seats are empty, the alarm is not activated. If they are occupied, the alarm is activated.

ii) Step 2 of the driver's circuit is activated and the system is waiting for the diode D2, located on the chest portion of the driver's safety belt, to be activated by the infrared beam of the emitting diode D_{E}, which will only occur if the belt is placed correctly, if this does not happen in a reasonable time, established by a timer circuit located in the internal circuit of the alarm, the alarm is activated, otherwise everything will develop normally.

As it can be appreciated, this invention is divided into three steps, each in a sequential order and depending on the other.

When the driver of the vehicle occupies his/her seat, the driver interrupts the beam of light between the diode D_{E} and the diode D1, there the driver should fasten the safety belt in a conventional way before moving the vehicle, otherwise, if the driver tries to evade safety provided by the vehicle's manufacturer, sequences of Steps 1 and 2 will be altered and trigger the audible and/or luminous alarm which is normally already incorporated in the vehicle and which preferably includes a timer circuit.

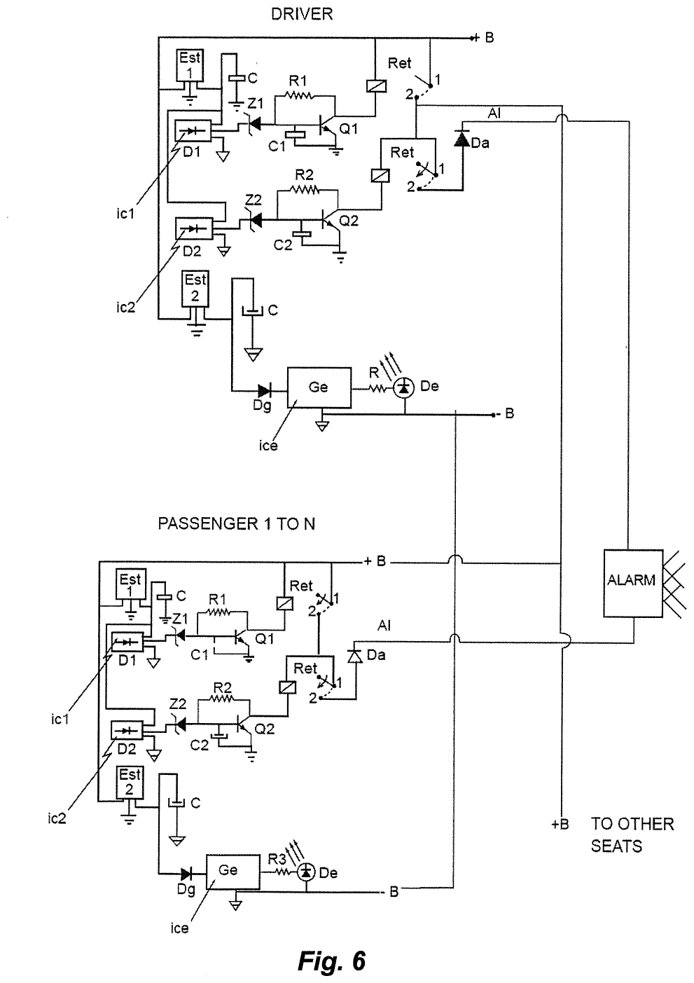

The present invention is embodied in the following circuit shown in FIG. 6 described below.

As it has been generally described in the block diagram of FIG. 5, the electronic circuit of FIG. 6 details the operation and construction, and since all circuits are the same, the operation of the driver circuit will be described.

As it can be seen, D_{E} is one of the infrared light emitting diodes located at one or more vehicle locations, which through Darlington type transistors 122, Q1 and Q2, both arranged to work at the ends of the load line: cut-off and saturation, activates or deactivates relays Re1 and Re2.

When the ignition key is activated in the ignition mode, the pulse generator Ge is activated which in turn generates a modulated medium frequency current by a low frequency pre-set by IC 1, integrated circuit of Step 1 linked to the receiving diode of said Step.

This current goes through DE, which in turn emits a beam of infrared light that broadly “illuminates” the places of each of the seats and their periphery.

The light emission is received by the receiving diode D1 which is a diode, plus an amplifier integrated circuit associated therewith, located in the seat of the chair, in this case of the driver.

This diode D1 and its integrated circuit IC1 amplifies the infrared light pulsed by the diode D_{E}, converting it into a pulsating voltage which in turn is sensed by the “Zener” diode Z1 and when the output pulses of the diode D1 exceed the threshold value of the Zener, 3.3 Volt for this case, Z1 will send to the base of the transistor Q1, which handles Re1, a reverse bias voltage which will put Q1 in the cut-off state, since Q1 was in saturation state and, therefore, fully conducting due to the bias current R1 lets flow.

In that state, diode D1 which receives light and the transistor Q1 in a cut-off or non-conducting state leaves the relay Re1 in position 1 and the alarm is not activated because the driver's seat is empty.

In addition, Step 2 does not work because it is not powered by voltage +B. When the driver sits in the driver's seat by positioning the ignition key in ignition mode or in the previous position, the diode D1 does not receive the infrared rays emitted by D_{E} because the person's own body locks out the infrared connection between the two D1-D_{E}, consequently the transistor Q1 is again in full conduction state and the relay Re1 moves from position 1 to position 2.

This causes the circuit corresponding to Step 2 to be powered by voltage +B, being thus enabled. That is, from the moment the person is seated in front of the wheel, Step 2 begins to work.

In this state, with the key in the ignition position or engine running, driver sitting in his seat and the circuits of Step 2, the diode D2 begins to command the system, i.e. the diode D2 or the various diodes D2 which are located in the safety belt in the diagonal strap portion that crosses the body of the driver.

Here there are two conditions:

i) if the belt is wound or misplaced, or placed behind the seat, not attached to its third point, which is a situation currently provided by all vehicles, or folded in such a way that the diode D2 is hidden from the infrared light beam, the following happens:
Transistor Q2, corresponding to Step 2 of the driver's seat, is energized by voltage +B and in the full conductive state since D2 is not receiving light, and Relay 2 is in position 2, which determines the conduction of diode Da, which in turn activates the alarm, until the D2 diode receives the infrared light beam.

ii) the belt is correctly positioned and attached to the third point, in this case the following occurs:
the infrared light beam illuminates the diode D2 whereby transistor Q2 passes the pulsating current that biases Zener Z2 and this in turn makes that transistor Q2 pass to the cut-off state by passing Relay 2 to position 1 and diode Da is not conducting, so the alarm is not activated.

This means that Steps 1 and 2 are two identical circuits cascaded and working on a reverse basis.

Biasing circuits of Q1 and Q2 are the resistors R1 and R2, both provide positive voltage coming from collectors Q1 and Q2 respectively.

Est 1 of FIG. 6 is a voltage stabilizer of 5 Volts that feeds the infrared receivers: the diodes plus their integrated circuits D1-IC1 and D2-IC2, since they must work with constant voltage values.

The electrolytic capacitors C of the stabilizers Est 1 and Est 2 stabilize and filter any minimal variation that could occur at the exit of both or by parasitic voltages induced therein.

Est 2 is the 3.3 Volt voltage stabilizer of the Ge, pulse generator.

Ge works with a constant voltage +B of 3 Volts, for this the diode Dg is placed at the output of Est 2, which causes a voltage drop of approximately 0.35 Volts.

Consequently, 2.95 Volt is the working voltage of the Ge.

The most significant detail of Ge is that it sends an electric current of about 16 mA through D_{E} under normal conditions.

Since the emitting diode D is constantly emitting a light invisible to the human eye, it was decided to lower the radiation significantly by placing a resistor R at the output of the pulsating signal reducing the power by 50%, allowing that only 7.8 mA through D_{E}, instead of 16 mA.

Finally, Da is a diode intended to isolate the alarm signals of Step 2.

The explanation thus far is simplified in Table 1 below, which is applicable for each of the passenger positions:

TABLE 1

| | Chof | | | | | | | | | | | | Signal |
|---|---|---|---|---|---|---|---|---|---|---|---|---|---|
| Cont | But | Cint | De | D1 | Z1 | Q1 | Re1 | D2 | Z2 | Q2 | Re2 | Da | Alarm |
| Yes | Des | Sin col. | Em Luz | R/Luz | Cond | Corte | Pos1 | Nr/Luz | N/Cond | XX | XX | XX | N/Act |
| Yes | Oc | M/col | Em Luz | Nr/Luz | N/Cond | Sat | Pos 2 | Nr/Luz | N/Cond | Sat | Pos 2 | Cond | Act |
| Yes | Oc | B/col | Em Luz | Nr/Luz | N/Cond | Sat | Pos 2 | R/Luz | Cond | Corte | Pos 1 | N/Cond | N/Act |

### Nomenclature of Table 1:

Chof But=Driver's seat: Des=unoccupied, Oc=occupied;

Cint=Belt: Sin Col=Not Placed, M/Col=Misplaced, B/Col=Well placed;

Receiving Diodes D1, D2: N/Luz=Not Receiving Light, R/Light=Receiving Light;

Emitting Diode D_{E}: Em Luz=Emits light;

Diode Da: Cond=conducting, N/Cond=not conducting;

Zener Diodes Z1, Z2: Cond=conducting, N/Cond=not conducting;

Re=Relay: 1=Position 1; 2=Position 2;

XX=Irrelevant;

Transistors Q1, Q2: Sat=Saturation, Cort=Cut-off; and

Alarm: Act=Activated, N/Act=Not Activated.

1. An electronic circuit device for constantly monitoring the correct use of the safety belt in the area of a vehicle, characterized in that it comprises:
a general power supply battery and an ignition key for said battery belonging to the vehicle;
one or more infrared light emitting diodes preferably located facing each or more of the positions of the driver and/or passenger on the roof or in the upholstery of the vehicle roof;
one or more pulse generators (G_{E}, . . . , G_{En}) connected to one or more infrared light emitting diodes;
one or more infrared light-emitting diodes located in the seat of the driver and of each passenger and/or at each position where a safety belt is fitted;
one or more infrared light receiving diodes in each of the safety belts corresponding to each seat preferably located in the diagonal strap of the safety belt;
one or more electronic circuits, each consisting of two steps known as Step 1 and Step 2 together associated with each safety belt, wherein Step 1 commanded by the infrared light receiving diode located in the seat of the driver’ and/or passengers determines the presence or absence of an occupant in the seat and Step 2 commanded by the infrared light receiving diode located on the diagonal strap of the safety belt, which is enabled according to the status of Step 1, determines the correct or incorrect use of the safety belt; and
an audible and/or luminous alarm with an associated timing circuit, within the area of use of the safety belt, which is integrated for all devices;
wherein each set of Steps 1 and 2 of the one or more operating circuits work autonomously for each of the safety belts arranged in the vehicle according to the logic of the following Table:

| | Chof | | | | | | | | | | | | Signal |
|---|---|---|---|---|---|---|---|---|---|---|---|---|---|
| Cont | But | Cint | De | D1 | Z1 | Q1 | Re1 | D2 | Z2 | Q2 | Re2 | Da | Alarm |
| Yes | Des | Sin col. | Em Luz | R/Luz | Cond | Corte | Pos1 | Nr/Luz | N/Cond | XX | XX | XX | N/Act |
| Yes | Oc | M/col | Em Luz | Nr/Luz | N/Cond | Sat | Pos 2 | Nr/Luz | N/Cond | Sat | Pos 2 | Cond | Act |
| Yes | Oc | B/col | Em Luz | Nr/Luz | N/Cond | Sat | Pos 2 | R/Luz | Cond | Corte | Pos 1 | N/Cond | N/Act |

wherein,
Cont=Ignition;
Chof But=Driver's seat: Des=unoccupied, Oc=occupied;
Cint=Belt: Sin Col=Not Placed, M/Col=Misplaced, B/Col=Well placed;
Receiving Diodes D1, D2: N/Luz=Not Receiving Light, R/Light=Receiving Light;
Emitting Diode D_{E}: Em Luz=Emits light;
Diode Da: Cond=conducting, N/Cond=not conducting;
Zener Diodes Z1, Z2: Cond=conducting, N/Cond=not conducting;
Re=Relay: 1=Position 1; 2=Position 2;
XX=Irrelevant;
Transistors Q1, Q2: Sat=Saturation, Cort=Cut-off; and
Alarm: Act=Activated, N/Act=Not Activated.

2. The electronic circuit device of claim 1, characterized in that each circuit associated with one or more safety belts comprises:
one or more infrared light emitting diodes, D_{E}, . . . , D_{En}, corresponding to each pair of Steps 1 and 2;
two or more pairs of diodes sensitive to the infrared light, D1-D2, . . . , Dn-Dn+1, corresponding to each pair of Steps 1 and 2;
two or more integrated circuits which amplify the signal emitted by the two or more pairs of diodes sensitive to the infrared light, IC1-IC2, . . . , ICn-ICn+1, corresponding to each pair of Steps 1 and 2;
two or more Zener diodes, Z1-Z2, . . . , Zn-Zn+1, corresponding to each pair of Steps 1 and 2;
at least two transistors, Q1-Q2, . . . , Qn-Qn+1, Darlington pair type, corresponding to each pair of Steps 1 and 2, being arranged to work at both ends of their curve: cut-off or saturation; and
one or more relays, Re1-Re2, . . . , Rn-Rn+1, corresponding to each pair of Steps 1 and 2.

3. The electronic circuit device of claim 1, characterized in that the one or more pulse generators, G_{E}, . . . , G_{En}, are activated when the key of the vehicle is in the starting position.

4. The electronic circuit device of claim 1, characterized in that the one or more infrared light emitting diodes, D_{E}, . . . , D_{En}, are conveniently located in the area of the vehicle to illuminate the one or more seats and the corresponding pectoral strap of the safety belt when properly positioned.

5. The electronic circuit device of claim 3, characterized in that the one or more diodes sensitive to infrared light of Step 1, D1, . . . , Din are located in the seat where the driver is located and in the seats of companions or passengers, and wherein the one or more diodes, D1, . . . , D1n, are illuminated by the one or more infrared light emitting diodes, D_{E}, . . . , D_{En}, while the seats are not occupied by a person.

6. The electronic circuit device of claim 3, characterized in that the one or more diodes sensitive to infrared light of Step 1, D1, . . . , D1n, are placed in the seat where the driver is located and in the seats of the companions, and wherein said one or more diodes sensitive to infrared light, D1, . . . , D1n, are not illuminated by the one or more infrared light emitting diodes, DE, . . . , DEn, while the seats are occupied by a person, the one or more integrated circuits, IC1, . . . , IC1n, being associated with said diodes, D1, . . . , Din.

7. The electronic circuit device of claim 2, characterized in that the one or more diodes, D2, . . . , D2n, are located on the chest strap of the safety belt of each seat of the vehicle where the driver and the companions are located, wherein said one or more diodes sensitive to the infrared light, D2, . . . , D2n, are illuminated by the one or more infrared light emitting diodes, D_{E}, . . . , D_{En}, only when each belt is correctly positioned, while it will not be illuminated by the one or more infrared light emitting diodes t, D_{E}, . . . , D_{En}, when each belt is wound up, placed behind the driver's or passenger's back, placed behind the respective seat, or twisted, so that the one or more receiving diodes, D2, . . . , D2n, rest on the chest of the passenger and hidden by the strap of the belt or by some element that prevents the passage of infrared rays.

8. The electronic circuit device of claim 6 or 7, characterized in that the one or more pairs of diodes sensitive to the infrared light, D1-D2, . . . , Dn-Dn+1, command the one or more pairs of Zener diodes, Z1-Z2, . . . , Z1n-Z2n, which in turn command the cut-off or conduction of the pairs of transistors, Q1-Q2, . . . , Qn-Qn+1, corresponding to the Darlington pair type, arranged to work at both ends of their curve: cut-off or saturation.

9. The electronic circuit device of claim 8, characterized in that the one or more pairs of transistors, Q1-Q2, . . . , Qn-Qn+1, corresponding to the Darlington pair type, command the one or more pairs of relays, Re1-Re2, . . . , Re1n-Re2n, wherein the transistor Q1 commands the relay Re1, the transistor Q2 commands the relay Re2, and so on as appropriate.

10. The electronic circuit device of claim 9, characterized in that In the case where the key of the vehicle is in the starting position and the seat is occupied, the transistor Q1 passes to the saturation state and the relay Re1 changes its position by feeding with +B the Q2 of Step 2 of the circuit, wherein if the diode D2 does not receive light, Z2 does not conduct and the relay Re2 is in position 2, according to Table 1, biasing the diode Db that feeds the alarm, which, when this situation lasts, for a time determined by the timer associated with the alarm, with the diode D2 of the safety belt corresponding to Step 2 not receiving the infrared light, as a signal that the belt is not correctly positioned, will trigger the alarm; on the other hand, if the diode D2 receives light, Z2 conducts and the transistor Q2 works in the saturation state, the relay Re2 goes to position 1, where it stops biasing the Db by cutting-off the supply of the alarm and therefore the alarm.

11. The electronic circuit device of claim 5, characterized in that the relay Re1 when the driver's seat is occupied enables Step 2 of the electronic circuit of the driver's seat.

12. The electronic circuit device of claim 11, characterized in that when the driver's seat is occupied, all the circuits corresponding to the passengers or companions are enabled by supplying a voltage +B to the Q1 manifold of Step 1 of each passenger's circuit.

13. The electronic circuit device of claim 10 or 11, characterized in that the relay 2, Re2, is in a condition to enable the audible and/or luminous alarm only in case the key of the vehicle is in the starting position, the seat is occupied and the diode that is in the safety belt does not receive light from the one or more emitting diodes, D_{E}, . . . , D_{En}, for more than 10 to 15 seconds, either because the belt is wound up, or placed behind the back or behind the respective seat or with the belt being twisted in such a way that the one or more receiving diodes, D2, . . . , D2n, rest on the passenger's chest and are hidden by the strap of the belt to the infrared rays or by some element that prevents the passage of infrared rays.

14. The electronic circuit device of claim 10 or 11, characterized in that the audible and luminous signal from the board of the vehicle is disabled when the key of the vehicle is in the starting position, the driver's seat is occupied and, if and only if, the safety belt is passed in front of the driver's chest, without being twisted and the diode sensitive to the infrared light, D2, . . . , D2n, is illuminated by the infrared light emitting diode, D_{E}, . . . , D_{En}.

15. The electronic circuit device of claim 14, characterized in that when the driver is seated it enables the circuits of the passengers' seats and, if and only if, any of the passengers is seated, it enables the alarm, in which case, in order for it not to sound, the safety belt must be fitted in such a way that the diode sensitive to infrared light, D2, . . . , D2n, of the passenger receives the infrared light.

16. The electronic circuit device of claim 15, characterized in that in the position of the passenger the relay Re2 is in a condition to enable the audible and luminous alarm of the board of the vehicle only in the event that the key of the vehicle is in the starting position, the driver's seat is occupied, the seat of any passenger is occupied and the diode that is in the safety belt of the driver and/or of that passenger does not receive light from the emitting diode, D_{E}, . . . , D_{En}, for more than 10 to 15 seconds, either because each belt is wound, placed behind the back of the driver or passenger, placed behind the respective seat, or twisted, in such a way that the one or more receiving diodes, D2, . . . , D2n, are resting on the passenger's chest and hidden by the strap of the belt to the infrared rays or by some element that prevents the passage of the infrared rays.

17. The electronic circuit device of claim 11, characterized in that When the key of the vehicle is in the starting position, the driver's seat is occupied and the passenger circuits are enabled by relay Re1 of Step 1 of the driver's seat, the one or more passenger circuits need the same steps to activate or deactivate the alarm, with the proviso that if no one occupies the one or more of the seats of the passengers the alarm is not enabled.
